(19) United States
(12) Patent Application Publication
(10) Pub. No.: US 2016/0063536 A1
(43) Pub. Date: Mar. 3, 2016

(54) METHOD AND SYSTEM FOR CONSTRUCTING USER PROFILES

(71) Applicant: InMobi PTE LTD., Singapore (SG)

(72) Inventors: Amit Deshpande, Bangalore (IN); Amal Tiwari, Bangalore (IN); Nandhagopal Gopalsamy, Bangalore (IN); Agradip Sarkar, Bangalore (IN)

(73) Assignee: InMobi PTE LTD., Singapore (SG)

(21) Appl. No.: 14/837,688

(22) Filed: Aug. 27, 2015

(30) Foreign Application Priority Data
Aug. 27, 2014 (IN) 4191/CHE/2014

(51) Int. Cl. G06Q 30/02; G06F 17/30

(52) U.S. Cl. CPC G06Q 30/0242; G06F 17/30598; G06F 17/30876; G06Q 30/0269

(57) ABSTRACT

A method and system construct user profiles. The method includes collecting user associated metadata for a plurality of user profiles, distributing the user profiles into one or more user groups, receiving a request for content from one or more user profiles, transmitting the content to the one or more user profiles, recording the response of the one or more use profiles, and updating the user groups.

### FIELD OF INVENTION

The present invention relates to constructing user profiles, and in particular, the invention relates to constructing user profiles for advertisement purposes.

### BACKGROUND

A successful advertisement campaign is the one that returns high Click-Through Rate (CTR), i.e. more number of users clicking an advertisement. Typically, users only click on advertisements that they find relevant and since every user has different needs and tastes it is highly unlikely that a single advertisement might please all the users. Thus, it is very critical for an advertisement network to identify users, their likes, dislikes and other attributes, which allows the advertisement network to serve advertisements that are more relevant to the user.

Several methods are implemented to identify and profile a user for this purpose. The advertisement networks use methods such as device fingerprinting, device recognition, cookies etc. These methods are used to pinpoint a user and user interests that are used to construct a user profile.

While all these known methods rely on data received from third party sources, very few actually involve taking data directly from user to create user profile. It is an obvious reasoning that a profile created using data received directly from user is more accurate when compared to data received from secondary sources. There is a need for creating more accurate user profiles for sending more personalized recommendations.

Thus in light of the above discussion, there is a need for a method and system that overcomes all these disadvantages.

### BRIEF DESCRIPTION OF THE INVENTION

The above-mentioned shortcomings, disadvantages and problems are addressed herein which will be understood by reading and understanding the following specification.

In at least one embodiment of a method and system for constructing user profiles, the system and method collect user associated metadata for a plurality of user profiles and distribute the user profiles into one or more user groups. In at least one embodiment, the distribution is affected by a pre-determined threshold in metadata similarity. In at least one embodiment, the system and method also receive a request for content from one or more user profiles, transmit the content to the one or more user profiles, wherein the content comprises at least one component requiring response, record the response of the one or more use profiles, and update the user groups. In at least one embodiment, the update includes the response inferred.

The system for constructing user profile comprises an advertisement serving platform, a communication network and one or more databases for storing plurality of data structures.

### BRIEF DESCRIPTION OF THE DRAWINGS

FIG. 1 is an environment in which user profiles are constructed.

FIG. 2 is a system level diagram of the advertisement serving platform.

FIG. 3 illustrates a flowchart for constructing user profiles.

FIG. 4 illustrates questionnaires served to a user having a mobile device.

FIG. 5 illustrates a block diagram of a computer server system.

### DETAILED DESCRIPTION OF THE INVENTION

In the following detailed description, reference is made to the accompanying drawings that form a part hereof, and in which is shown by way of illustration specific embodiments, which may be practiced. These embodiments are described in sufficient detail to enable those skilled in the art to practice the embodiments, and it is to be understood that other embodiments may be utilized and that logical, mechanical, electrical, and other changes may be made without departing from the scope of the embodiments. The following detailed description is, therefore, not to be taken in a limiting sense.

The environment 100 includes a first computing device 110, a second computing device 120, a third computing device 130. Examples of well-known computing devices include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, mobile phones, smart-phones, personal digital assistants (PDAs), and tablets.

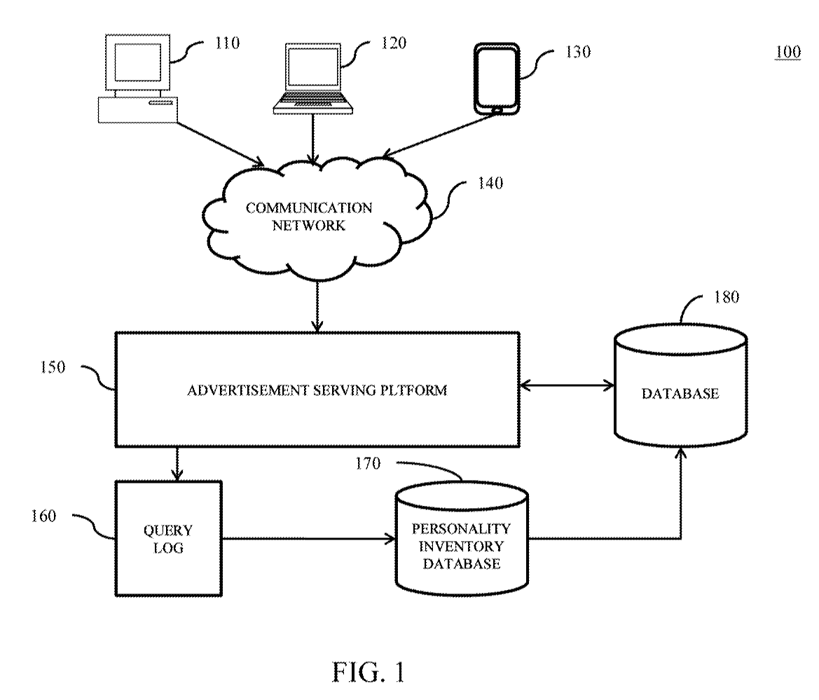

FIG. 1 includes a communication network 140. The communication network 140 refers to one or more of variety of networks or other types of communication connections. For example, the network 140 may be an internet, an intranet network, a local area network, a wireless connection, a hardwired connection and the like. FIG. 1 includes an advertisement-serving platform 150. The advertisement-serving platform 150 refers to a computing platform that enables advertisers to manage, deliver and display advertising content that publisher web server (not shown in figure) deliver to computing device 110, computing device 120, and computing device 130. Examples of advertisement-serving platform 210 can be Google Adsense®, Yahoo! Panama™, InMobi®, and the like. The first computing device 110, the second computing device 120, and the third computing device 130 communicates with the advertisement-serving platform 150 via the communication network 140. The common functionalities of the advertisement-serving platform 150 are to upload advertisements from plurality advertisers, trafficking advertisements according to differing business rules, targeting advertisements to different users, tuning and optimizing based on results obtained, reporting impressions, predicting click-through rates, post-clicks to generate revenue module and the like. The advanced functionalities of the advertisement-serving platform 150 include customizing advertisements according to the changing trends, frequency capping, sequencing advertisements and the like.

FIG. 1 includes a query log 160. The query log 160 is a database that stores queries submitted by one or more user using the computing device 110, the computing device 120, and the computing device 130. The query log 160 also helps in improving relevance of retrieved results or other purposes. The query log 160 also submits the queries to a personality inventory database that pulls out relevant questions from one or more sources. In an embodiment, the queries to the query log 160 may be submitted by the user. In another embodiment, the queries may be submitted by the administrator of the advertisement-serving platform 150. In yet another embodiment, the queries are submitted automatically to get a system update.

FIG. 1 includes a personality inventory database 170 for storing one or more types of user personality. The personality inventory database 170 collects information about one or more users from trusted sources. Examples of trusted sources include but not limited to profile server, third party servers and the like

The environment 100 includes a database 180. The database 180 is used for storing one or more types of information. The information stored in the database 180 may include but is not limited to information about users, information about advertisements, information about publishers, advertisement access control table, charging list information, fees calculating information, geographic locations, advertising zones, point of interest data, and optical criteria. The database 180 may also include other types of metadata of the advertisement files sent to plurality of computing devices. The database 180 stores the advertisement requests received by the advertisement-serving platform 150. The advertisement-serving platform 150 communicates with the database 180 to serve advertisements to the first computing device 110, the second computing device 120, and the third computing device 130.

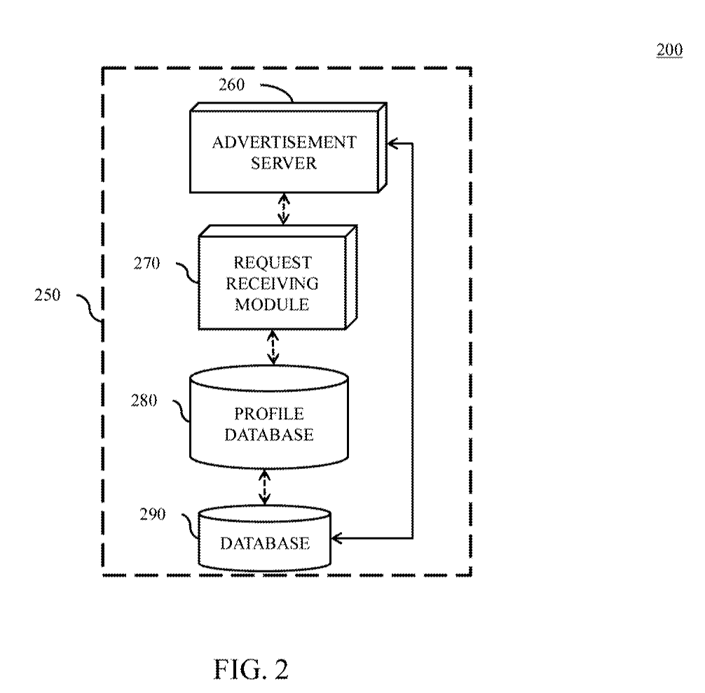

FIG. 2 is a system 200 of the advertisement-serving platform. System 200 includes the advertisement-serving platform 250. In an embodiment, the advertisement-serving platform 250 and the advertisement-serving platform 150 are the same. In another embodiment, the advertisement-serving platform 250 and the advertisement-serving platform 150 are different from each other. In the system 200, the advertisement server 260 refers to a computer system that stores, maintains, and serves advertisements to one or more applications. The advertisement-server 260 programs, tracks and report several statistics about application visitors that are used by advertisement providers to generate revenue. In an embodiment, the advertisement server 260 is a local server. A local server serves advertisements only to a single web publisher. In another embodiment, the advertisement server 260 is a remote server. A remote server serves advertisements to plurality of publishers. In yet another embodiment, the advertisement server 260 is a third party server. Further, the advertisement server 260 interacts with the publisher web server via the communication network 130 for publishing the advertisements in the advertising slots of the web content.

In the system 200, the advertisement-serving platform 250 includes the request-receiving module 270. The request-receiving module 270 receives one or more queries from one of the computing device 110, the computing device 120 and the computing device 130. In an embodiment, the request-receiving module receives the one or more advertisement requests from one of the computing device 110, the computing device 120 and the computing device 130 through the advertisement server 260. The advertisement request includes information about the devices connected to one of the computing device 110, the computing device 120 and the computing device 130, as well as the information about the computing device 110, the computing device 120 and the computing device 130. In at least one embodiment, the request-receiving module 230 receives an advertisement request corresponding to execution of a particular application or a web browser from one of the computing device 110, the computing device 120, and the computing device 130. Further, the request-receiving module 230 discards the advertisement requests that do not match a standard header format. In an embodiment, if the date of creation of the advertisement is not given in a proper format (For example, if the advertisement server receives an advertisement request on Jan. 1, 2014 and the advertisement header has the information that the advertisement was created on Feb. 1, 2015), the request-receiving module 230 discards that particular advertisement request. In another embodiment, the request-receiving module 230 discards the advertisement request received from prohibited and blacklisted mobile devices.

When the request-receiving module 230 receives an advertisement-request, the relevant advertisement is served to the device requesting for the advertisement. The request-receiving module 230, interacts with a profile database 280 and transmits the request received from one of the computational device 110, the computational device 120, and the computational device 130. The profile database 280 interacts with a profile server (not shown in figure) to obtain the information about plurality of user profiles.

The advertisement server 250 in the system 200 includes a database 290. The database 290 is used to store plurality of data structures. In an embodiment, the database 290 and the database 180 are the same. In another embodiment, the database 290 and the database 180 are different. In an embodiment, the profile database 280 and the database 290 are the same. In another embodiment, the profile database 280 and the database 290 are different.

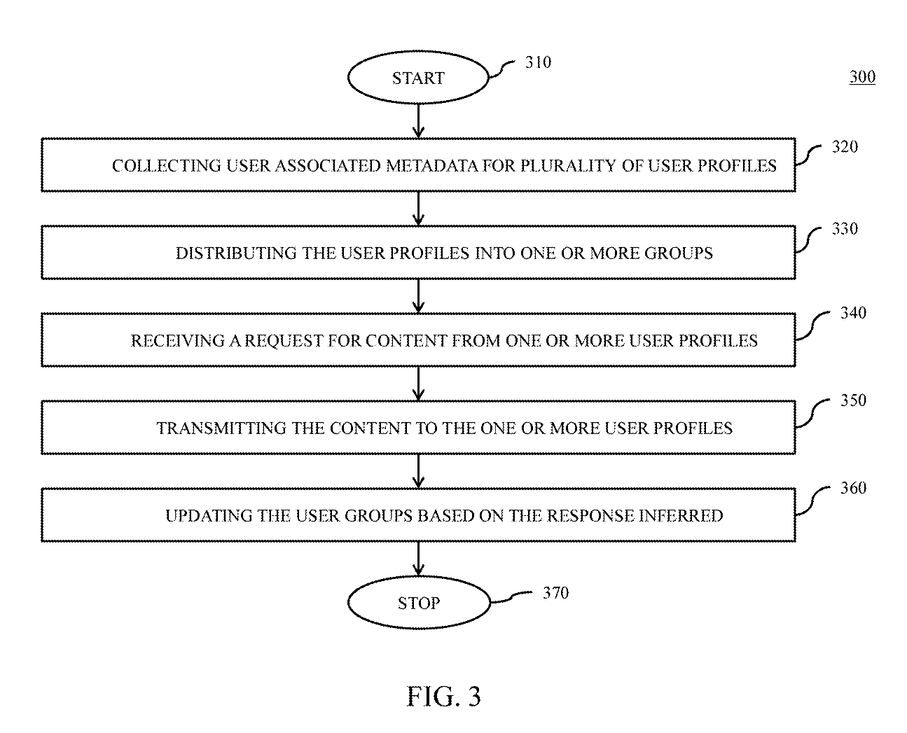

FIG. 3 illustrates a flowchart 300 for constructing user profiles. The flowchart initiates at step 310.

At step 320, the advertisement-serving platform 250 collects user associated metadata for plurality of user profiles. The advertisement-platform 250 interacts with one or more trusted sources to collect user associated metadata. In an embodiment, the user-associated metadata is collected by the advertisement-serving platform 250 by interacting with one or more profile servers (not shown in figure). In another embodiment, the user-associated metadata is provided by the user itself. In yet another embodiment, the user-associated metadata is collected by using one or more user identification methods. The profile server provides information of plurality of users. Examples of the metadata provided by the profile server includes may include but not limited to user interests, user gender, user browsing history, location of the user, trends followed by the user and the like. The collected metadata about user profiles are stored in the profile database 280. The collected metadata is transmitted to for further processing.

At step 330, the collected metadata about the plurality user profiles is distributed to one or more groups. The distribution of the plurality of the user profiles is based on one or more data points. The one or more data points refer to one or more attributes collected by the profile server. Examples of the data points according to which the plurality of user profiles include but are not limited to user interest, user gender, user location and the like. Each of the plurality of user profiles is distributed to a group. Therefore, each group in the plurality of user groups has an attribute of plurality of users. The distributed user profiles according to one or more data points are stored in the database 290 of the advertisement-serving platform 250.

At step 340, the advertisement-serving platform 250 receives an advertisement request from one of the computational device 110, the computational device 120 and the computational device 130. The advertisement-request is received by the advertisement server 260 of the advertisement-serving platform 250. The received advertisement-request is analyzed by the advertisement server 260 for serving one or more relevant advertisements. The advertisement server 260 transmits the received advertisement request to the request receiving module 270. The request-receiving module 270 transmits the advertisement request to the profile database 280 to serve one or more relevant advertisements from 290.

At step 350, the advertisement server 260 transmits the relevant advertisement to one of the computational device 110, the computational device 120 and the computational device 130, which has sent an advertisement request. To pick one or more relevant advertisements from the database 190, the advertisement-serving platform first sends a questionnaire to the device that has sent an advertisement-request. The questionnaire sent to the device that has sent an advertisement request can be in one or more forms. Examples of the questionnaire forms can include but not limited to text, objective, video, audio and the like. The questionnaires are selected by the advertising-serving platform based on the data points obtained for each of the user present in the profile database 280. The data points that are present in the profile database 280 serve as a pre-determined threshold. The questionnaires are selected based on the pre-determined threshold, which comprises of one or more data points.

The questionnaires are sent to the device that has sent an advertisement request to build a better profile of the user. For example, if an advertisement request is sent by a device which is distributed under the group by the profile server as 24 years, male, Bangalore, then a relevant questionnaire such as Are you interested in “movies” or “disco” is posed. The response of the user is recorded and stored by the advertisement-serving platform 250 for posing future questions. If the user selects the answer as “movies”, then a further question may be posed such as Are you interested in “Hollywood movies” or “Bollywood movies”? and the like. Now if the user selects “Bollywood movies”, the advertisement-serving platform 250 may choose to pose further questions or serve relevant advertisements such as theatres showing Bollywood movies, Bollywood movie songs, Bollywood stores and the like. In another example, if an advertisement request is sent by a device, which is grouped as 23 years, Female, Delhi, then questionnaires such as are you interested in “Online shopping” or offline shopping can be posed. If the user responds as “online shopping”, then further questions may be asked as the type of article to be shopped, shipping options and the like. The user responds to the questionnaire posed and then relevant advertisements such as the websites in which those articles The relevant selection of the questionnaire is selected from the database 190, which has plurality of questionnaires. The relevant questionnaires are sent to the user to increase the click-through rate of the advertisement served.

At step 360, the user groups are updated based on the response received by the user. The responses of each user from the plurality of the user profiles in the user group is updated and stored in the database 190. In an embodiment, these responses are stored for serving better advertisements for the user. In another embodiment, the responses from plurality of users are recorded for the purpose of data analytics. The flowchart terminates at step 370.

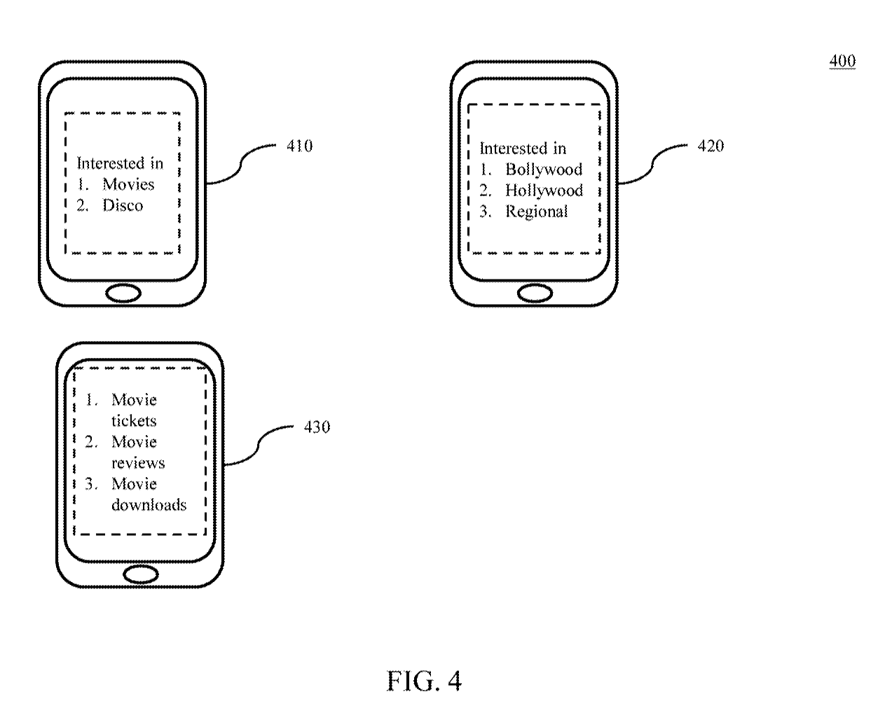

FIG. 4 illustrates an example 400 in which a questionnaire served to a user having a computing device. The advertisement-serving platform 250 receives an advertisement request from one of the computing device 110, the computing device 130, and the computing device 140. Based on the methods as explained above, a questionnaire is posed to the user of the computing device 110, the computing device 120 and the computing device 130. In 410, a questionnaire selected from the database 290 is posed to the one of the computing device 110, the computing device 120 and the computing device 130. For example, in 410, a question such as “Interested in 1. Movies 2. Disco” is posed. The user of the computing device can select one of the options. In an embodiment, questions are served in an objective form. In another embodiment, questions are posed in video and audio form. The user responds to the question in one or more forms. The response by the user is recorded by the advertisement-serving platform 250 and is stored in the database 290. The recorded response is further checked and a second questionnaire as shown in 420 is served to the user with one of the computing device 110, the computing device 120 and the computing device 130. As shown in example, 420 the questionnaire such as “Are you interested in 1. Bollywood 2. Hollywood 3. Regional?”. The questionnaire is selected if the user has selected the option “Movies” in the first questionnaire. The response of the user with the computing device is recorded by the advertisement-serving platform 250. The one or more advertisements are served to the user having computing device 110, the computing device 120, and the computing device 130. The one or more advertisements served on the computing device 110, the computing device 120 and the computing device 130 is shown in 430. In an embodiment, the example of 430 can be a follow-up questionnaire. The options which are given as 1. Movie tickets 2. Movie reviews 3. Movie downloads are the questionnaire to construct the user profile to a higher level and to understand the user interest.

The user responds to the questionnaire and the advertisements are served according by the advertisement server. For example, the user may click on the option 1 which is labeled as “Movie tickets”. The user is now served with the advertisements by the movie ticket providers. If the user clicks on the option 2, which is labeled as “Movie reviews”, the user is served with the advertisements of the various Movie Review sites. In another embodiment, the example 430 itself can be an advertisement. If the user choose options 1. Bollywood Movies in 420, then the advertisements of the movie ticket providers, movie reviews of the Bollywood movies, Movie Downloads and the like is served. The user may select the desired option to get the relevant one or more advertisements.

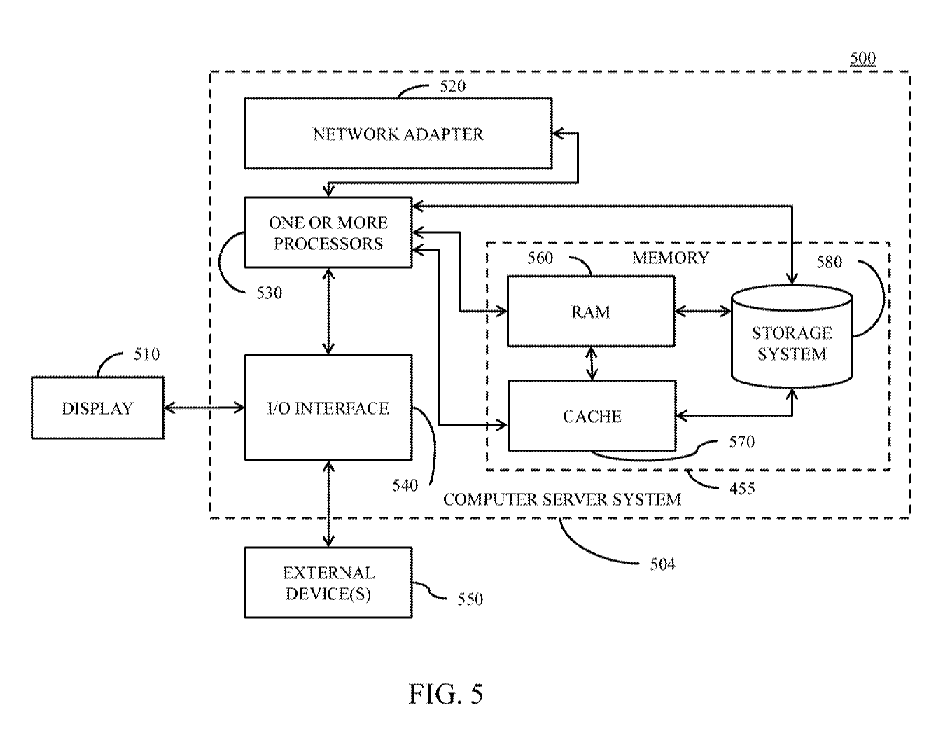

FIG. 5 illustrates a block diagram of a computer node 500 of the advertisement-serving platform 250. The computer node 500 of the advertisement-serving platform 550 includes a computer server 505 that is operational with numerous other general purpose or special purpose computing system environments or configurations. Examples of well-known computing systems, environments, and/or configurations that may be suitable for use with computer server 505 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, and mainframe computer systems.

In FIG. 5, the computer server 505 in the computer node 500 of the advertisement-serving platform 250 is shown in the form of a general-purpose computing device. The components of computer server 505 include, but are not limited to, processing unit 530, a system memory 555, a network adapter 520, an input-output (I/O) interface 540 and one or more buses that couples various system components to processing unit 530.

The one or more buses represents one or more of any of several types of bus structures, including a memory bus or memory controller, a peripheral bus, an accelerated graphics port, and a processor or local bus using any of a variety of bus architectures. The architectures includes but are not limited to Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer server 505 typically includes a variety of computer system readable media. Such media may be any available media that is accessible by computer server 505, and includes both volatile and non-volatile media, removable, and non-removable media. In an embodiment, the system memory 555 includes computer system readable media in the form of volatile memory, such as random access memory (RAM) 560, and cache memory 570. Computer server 505 may further include other removable/non-removable, non-volatile computer system storage media. In an embodiment, the system memory 555 includes a storage system 580.

Computer server 505 can communicate with one or more external devices 550, and a display 510, via input-output (I/O) interfaces 540. In addition, computer server 505 can communicate with one or more networks such as a local area network (LAN), a general wide area network (WAN), and/or a public network (for example, the Internet) via the network adapter 520.

It can be understood by one skilled in the art that although not shown, other hardware and/or software components can be used in conjunction with the computer server 505. Examples, include, but are not limited to microcode, device drivers, redundant processing units, external disk drive arrays, RAID systems, tape drives, data archival storage systems, and the like.

It should be understood that the foregoing pertains only to the exemplary embodiments of the present invention, and that numerous changes may be made to the embodiments described herein without departing from the spirit and scope of the invention.

We claim:

1. A method for constructing a user profile, the method comprising:
executing a program by a computer system that transforms the computer system into a machine to perform:
collecting user associated metadata for a plurality of user profiles;
distributing the user profiles into one or more user groups organized within a memory of the computer system, wherein the distribution is affected by a pre-determined threshold in metadata similarity;
receiving a request for content from one or more user profiles;
transmitting the content to the one or more user profiles, wherein the content comprises at least one component requiring response;
recording the response of the one or more use profiles; and
updating the user groups, wherein the update comprises the response inferred.

2. The method of claim 1, wherein the content comprises at least a questionnaire with one or more options for user response.

3. The method of claim 1, wherein based on the number being over the threshold, transmitting one or more advertisements to the user's computing device, the one or more advertisements based at least in part on the given category.

4. A system for constructing user profiles, the system comprising:
an advertisement serving platform that includes a processor and a memory coupled to the processor that includes code that is executable by the processor to access one or more databases;
a communication network coupled to the advertising serving platform; and
a profile database, coupled to the communication network, that is accessible by the advertising serving platform and that stores a plurality of data structures, wherein the profile database comprises at least the metadata associated with the user profiles and wherein the profile database is configured for updating by the communication network.

5. The system of claim 4 further comprising a query log for storing queries submitted by one or more advertisement servers.

6. The system as claimed in claim 4 further comprises a request receiving module for receiving requests from one or more devices; and at least one database for storing the plurality of data structures.

7. The system as claimed in claim 5, wherein the plurality of data structures comprises of mobile applications, advertisements, advertisement requests, plurality of resettable identifiers, user information, publisher information and ad server information.
